(19) United States
(12) Patent Application Publication
(10) Pub. No.: US 2026/0001035 A1
(43) Pub. Date: Jan. 1, 2026

(54) AIR PURIFIER USING MOSS, AIR PURIFYING SYSTEM, AND OPERATING METHOD THEREOF

(71) Applicant: TAIGA GLOBAL INC., Seongnam-si (KR)

(72) Inventors: Won Seok LEE, Gwacheon-si Gyeonggin-do (KR); Chang Hun JEONG, Gwacheon-si Gyeonggi-do (KR)

(21) Appl. No.: 19/319,637

(22) Filed: Sep. 4, 2025

Related U.S. Application Data
(63) Continuation of application No. PCT/KR2024/003996, filed on Mar. 28, 2024.

(30) Foreign Application Priority Data
Mar. 28, 2023 (KR) 10-2023-0040359
Mar. 27, 2024 (KR) 10-2024-0042129

(51) Int. Cl. B01D 53/85; A01G 7/04; A01G 22/30; B01D 53/34

(52) U.S. Cl. CPC B01D 53/85; A01G 7/045; A01G 22/30; B01D 53/346; B01D 2257/504; B01D 2258/06

(57) ABSTRACT

An air purifier using moss, of the present invention, presents that a plurality of light-transmitting members passing through a moss sheet in the height direction of moss are provided so that sufficient light may be provided to the lower portion of the moss by the light-transmitting members. In addition, the present invention relates to an air purifying system using moss wherein the air purifier using moss is sprayed with an appropriate amount of water at the appropriate time, and an operating method thereof. An air purifying system of the present invention comprises: an air purifier comprising moss and a display unit; and a sprayer that communicates with the air purifier and sprays the moss with water, wherein the air purifier detects water spray from the sprayer and changes information displayed on a display.

### TECHNICAL FIELD

The present disclosure relates to a new type of air purifier using moss, which enhances the purification capacity by moss, and to an air purifying system using moss in which an appropriate amount of water is sprayed to the moss of an air purifier at an appropriate time and a method for operating the system.

### BACKGROUND ART

Recently, interest and demand for indoor air purifiers have increased due to concerns about health caused by indoor fine dust. Since filter-based air purifiers that require periodic filter changes have limitations in efficiently removing fine dust, interest in air purifiers using moss has gradually increased.

Moss is a non-vascular plant that belongs to bryophytes. Since moss has no vascular tissues, it cannot grow tall unlike other plants, but it grows by crawling on the earth or by hanging on stems or branches of vascular plants.

Since moss has no cuticle layer for filtering foreign substances like leaves, it can purify more fine dust than trees when they occupy the same area. For this reason, moss has recently attracted much interest as an air-purifying plant.

Nowadays, various technologies for purifying air to a clean state and adjusting indoor humidity using moss have been disclosed. For example, Korean Patent Application Publication No. 10-2013-0013098, Korean Registered Patent Publication No. 10-2014700, and Korean Registered Patent Publication No. 10-2292339 disclose a frame-type air purifier using moss that provides a function as a simple air purifier as well as a function of greening the indoor environment.

Moss grown at home for air purification is mainly Racomitrium canescens, which purifies indoor carbon dioxide into oxygen when conditions for photosynthesis are met.

However, conventional general air purifiers using moss, as disclosed in the above references, have low air purifying performance because photosynthesis is not actively performed due to insufficient supply of light, which is most necessary for photosynthesis. That is, the light supplied to moss is conventionally only indoor light, which results in insufficient photosynthesis.

In particular, in the case of moss used for a frame-type moss panel, light is supplied only to the surface of the moss, and the light supply decreases toward the lower portion (root portion) of the moss, whereby photosynthesis is not performed.

In the case of air purifiers using moss, moisture, in addition to light, needs to be properly supplied for the growth and development of moss. For example, Korean Patent Application Publication No. 10-2021-01118595, Korean Registered Patent Publication No. 10-2125218, and Korean Registered Patent Publication No. 10-2455545 disclose the feature that water is sprayed onto moss from a water tank provided in a purifier itself.

However, according to the above prior arts, a purifier needs to comprise a water tank and a water spraying apparatus, which causes a complicated structure, increased costs, and inconvenience due to periodic water replacement.

### SUMMARY

### Technical Problem

The present disclosure is intended to solve the problems of the above-described prior arts. The present disclosure is intended to provide an air purifier that enables light to be uniformly supplied to all parts of moss planted on a moss sheet, thereby enhancing the photosynthetic effect.

The present disclosure is also intended to provide an air purifier in which light is supplied based on information obtained by sensing illuminance and humidity, thereby enabling optimum photosynthesis.

In addition, the present disclosure is intended to further provide various information using a structure that supplies light to moss. Specifically, the present disclosure is intended to provide an air purifier using moss, an air purifying system, and a method of operating the same, in which various information is displayed by using a plurality of light sources for supplying light to moss in the air purifier.

The present disclosure is intended to provide an air purifying system using moss comprising a sprayer for spraying water outside an air purifier using moss so that an appropriate amount of water may be sprayed at an appropriate time, and a method of operating the same.

The present disclosure is intended to provide an air purifying system using moss that enables water to be sprayed to moss with a simple structure and low cost, and a method of operating the same.

### Technical Solution

To this end, in an embodiment, the present disclosure provides an air purifier using moss comprising: a moss sheet on which moss is planted on a front surface; a plurality of light-transmitting members installed to penetrate the moss sheet and the moss and formed of a transparent material so that light may pass through; and a light source unit disposed on a rear surface of the moss sheet to supply light to the respective light-transmitting members.

In the air purifier using moss according to an embodiment of the present disclosure, each light-transmitting member is formed in a rod or pipe shape having a height reaching the top of moss planted on the moss sheet.

The air purifier using moss according to an embodiment of the present disclosure may further comprise a panel unit in which the light-transmitting members are integrated.

In the air purifier using moss according to an embodiment of the present disclosure, the panel unit may be formed of a non-transparent material.

The air purifier using moss according to an embodiment of the present disclosure may further comprise a non-transparent shielding plate between the front surface of the panel unit and the moss sheet.

The air purifier using moss according to an embodiment of the present disclosure may further comprise a case that surrounds the border and the rear surface of the moss sheet, and the light source unit may be provided between the rear surface of the moss sheet and the case.

In the air purifier using moss according to an embodiment of the present disclosure, the case may comprise an air inlet, through which air is sucked in, and a blower fan that blows the air sucked in through the air inlet.

In the air purifier using moss according to an embodiment of the present disclosure, the case may further comprise a humidity sensor that senses humidity.

In the air purifier using moss according to an embodiment of the present disclosure, the case may further comprise an illuminance sensor that senses illuminance.

In the air purifier using moss according to an embodiment of the present disclosure, the light source unit may comprise a board having multiple light-emitting devices (LEDs).

The air purifier using moss according to an embodiment of the present disclosure may further comprise a controller that controls the light emission of each LED, the humidity, or the illuminance.

In an embodiment, the present disclosure provides an air purifying system using moss including: an air purifier comprising moss and a display unit; and a sprayer that sprays water onto the moss in communication with the air purifier, wherein the air purifier detects water spraying by the sprayer and changes information displayed on the display unit.

According to an embodiment, the display unit may comprise a plurality of light-transmitting members formed of a transparent material to enable light to pass through and a light source unit that supplies light to the respective light-transmitting members.

According to an embodiment, the air purifier may comprise a moss sheet on which moss is planted on a front surface, and the plurality of light-transmitting members are installed to penetrate the moss sheet such that the light supplied by the plurality of light-transmitting members is emitted by passing through the moss when viewed from the front.

According to an embodiment, the sprayer may include a water spraying detection sensor that detects whether water is sprayed; and a communication unit that transmits a sensing signal to the air purifier when the water spraying detection sensor detects water spraying.

According to an embodiment, the air purifier may change the information displayed on the display unit when the sensing signal is received from the sprayer.

According to an embodiment, the air purifier may further comprise a panel unit, in which the light-transmitting members are integrated, wherein the panel unit may be formed of a non-transparent material.

In an embodiment, the present disclosure provides a method of operating an air purifying system using moss, which comprises an air purifier including moss and a display unit, and a sprayer, comprising the steps of: transmitting a sensing signal to the air purifier through wireless communication when water spraying by the sprayer is detected; and displaying, by the air purifier, information on the display unit based on the sensing signal.

According to an embodiment, the display unit may divide the entire front area into multiple regions such that each region sequentially emits light exclusively for a predetermined time.

According to an embodiment, after the step of displaying information on the display unit, the method may further include the steps of: in the air purifier, measuring humidity of the moss; and changing the information displayed on the display unit when the measured humidity is equal to or greater than a predetermined reference value.

According to another embodiment, the present disclosure provides a method of operating an air purifying system using moss, which includes an air purifier comprising moss and a display unit, and a sprayer, including the steps of: determining, by the air purifier, whether the time for spraying water has come; displaying information requesting water spraying on the display unit when the time for spraying water has come; transmitting a sensing signal to the air purifier through wireless communication when water spraying from the sprayer is detected; and changing, by the air purifier, the information displayed on the display unit based on the received sensing signal.

According to an embodiment, the display unit may divide the entire front area into multiple regions such that each region sequentially emits light exclusively for a predetermined time.

According to an embodiment, after the step of displaying information on the display unit, the method may further include the steps of: in the air purifier, measuring humidity of the moss; and displaying information requesting a stop of water spraying on the display unit when the measured humidity is equal to or greater than a predetermined reference value.

### Effects of the Invention

As described above, since the air purifier according to the present disclosure comprises a plurality of light-transmitting members, light may be uniformly supplied from the top, via the middle, to the lower part of the moss planted on the moss sheet, thereby enhancing the photosynthetic effect.

Additionally, since the air purifier according to the present disclosure further comprises a humidity sensor, the timing when moisture is supplied to the moss may be identified, and thus, light may be supplied at the exact timing, thereby maximizing the photosynthetic effect.

The air purifying system using moss and the method of operating the same according to the present disclosure have at least one of the following effects.

According to the present disclosure, since the air purifier does not include a water tank or a spraying device inside, it has a simple structure and it is cost-effective.

According to the present disclosure, since light may be uniformly supplied to the moss of the air purifier, the photosynthetic effect in the moss may be enhanced.

According to the present disclosure, since an appropriate amount of water is sprayed to the moss at an appropriate time in the air purifier, the moss grows well and the photosynthetic effect in the moss may be maximized.

According to the present disclosure, since the air purifier comprises a display unit, various information may be provided to a user. For example, various information related to water spraying, such as a request for water spraying or a stop of water spraying, and life information, such as weather, time, day of week, news, etc.

According to the present disclosure, since outdoor light is not required, the moss sheet may be installed in various locations, and may be freely combined with other devices, thereby enabling the development of various products and applications.

### BRIEF DESCRIPTION OF THE DRAWINGS

FIG. 1 is a schematic configuration diagram of an air purifying system according to an embodiment of the present disclosure.

FIG. 2 is an exploded perspective diagram of an air purifier included in an air purifying system according to an embodiment of the present disclosure.

FIG. 3 is a cross-sectional diagram of an air purifier according to an embodiment of the present disclosure.

FIG. 4 is an example of a light-transmitting member according to an embodiment of the present disclosure.

FIG. 5 is an enlarged diagram of the part “A” of FIG. 3 according to an embodiment of the present disclosure.

FIG. 6 is an enlarged diagram of the part “A” of FIG. 3 according to another embodiment of the present disclosure.

FIG. 7 is a front-side view diagram illustrating the appearance of an air purifier according to another embodiment of the present disclosure.

FIG. 8 is a rear-side view diagram illustrating the appearance of an air purifier according to another embodiment of the present disclosure.

FIG. 9 is an exploded perspective diagram of an air purifier according to another embodiment of the present disclosure.

FIG. 10 is a rear-side view diagram illustrating a case of an air purifier according to another embodiment of the present disclosure.

FIG. 11 is a cross-sectional diagram of an air purifier according to another embodiment of the present disclosure.

FIG. 12 is an enlarged diagram of the part “B” of FIG. 11 according to an embodiment of the present disclosure.

FIG. 13 is an exploded perspective diagram of an air purifier according to another embodiment of the present disclosure.

FIG. 14 is an example illustrating the structure of the interior of a sprayer included in an air purifying system according to an embodiment of the present disclosure.

FIG. 15 is a configuration block diagram illustrating the operation of an air purifying system according to an embodiment of the present disclosure.

FIG. 16 is an example of a display unit of an air purifier according to an embodiment of the present disclosure.

FIG. 17 is an example of a screen displayed on a display unit of an air purifier according to an embodiment of the present disclosure.

FIG. 18 is a flow diagram illustrating the operation of an air purifying system according to an embodiment of the present disclosure.

FIG. 19 is a flow diagram illustrating the operation of an air purifying system according to another embodiment of the present disclosure.

FIG. 20 is an example showing a display unit according to an embodiment of the present invention divided into multiple regions.

### DETAILED DESCRIPTIONS OF EXEMPLARY EMBODIMENTS

Hereinafter, some embodiments of the present disclosure will be described in detail with reference to the accompanying drawings. With regard to the reference numerals of the components of the respective drawings, it should be noted that the same reference numerals are assigned to the same components even though they are shown in different drawings. In addition, in describing the present disclosure, a detailed description of a well-known configuration or function related the present disclosure, which may obscure the subject matter of the present disclosure, will be omitted.

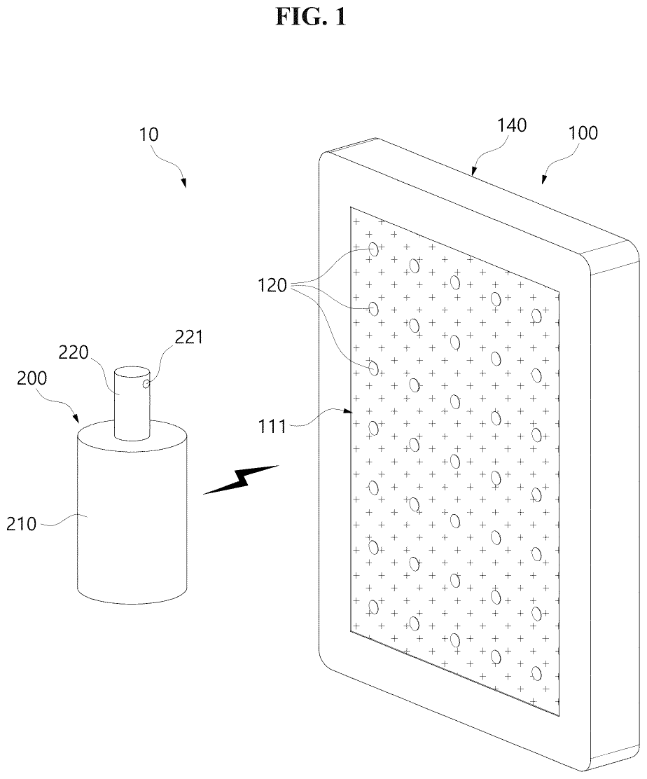

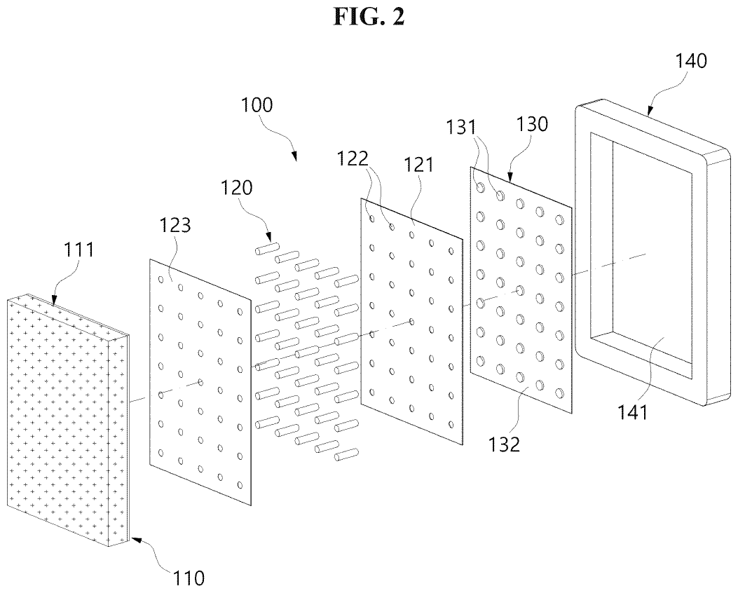

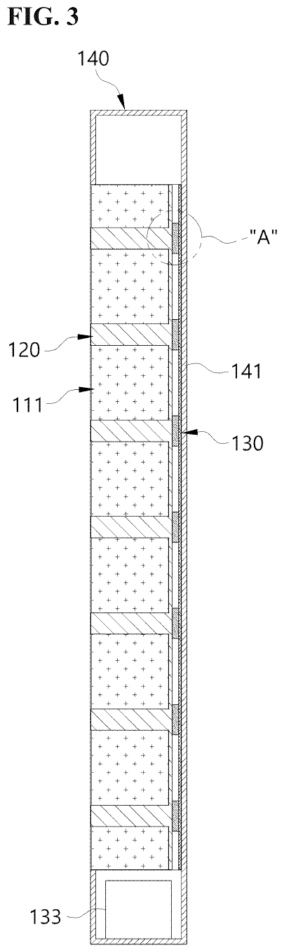

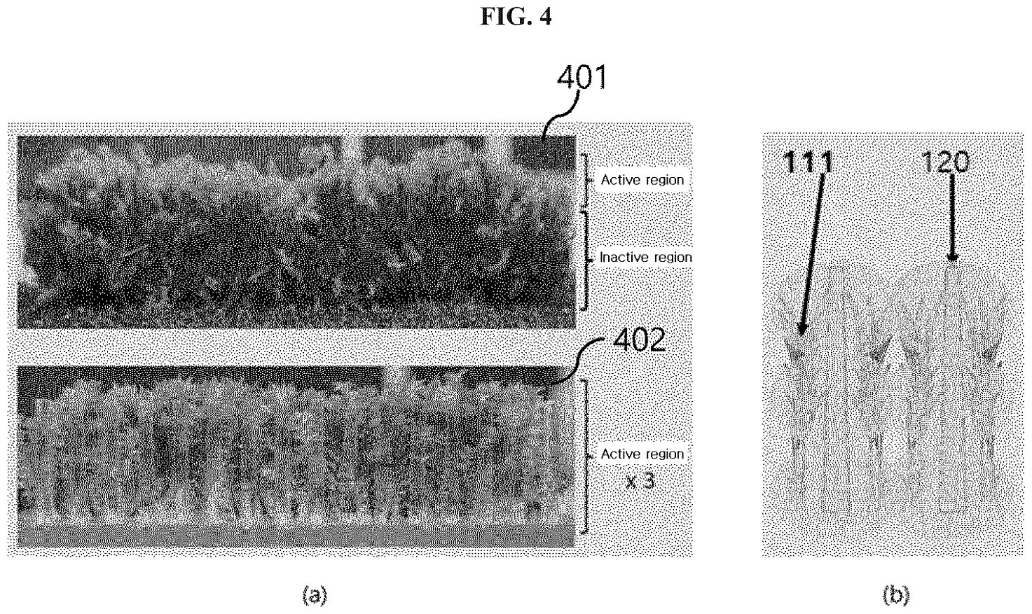

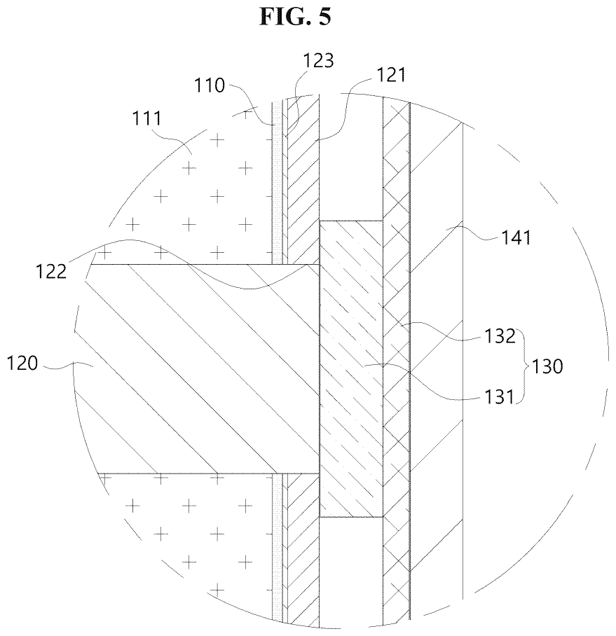

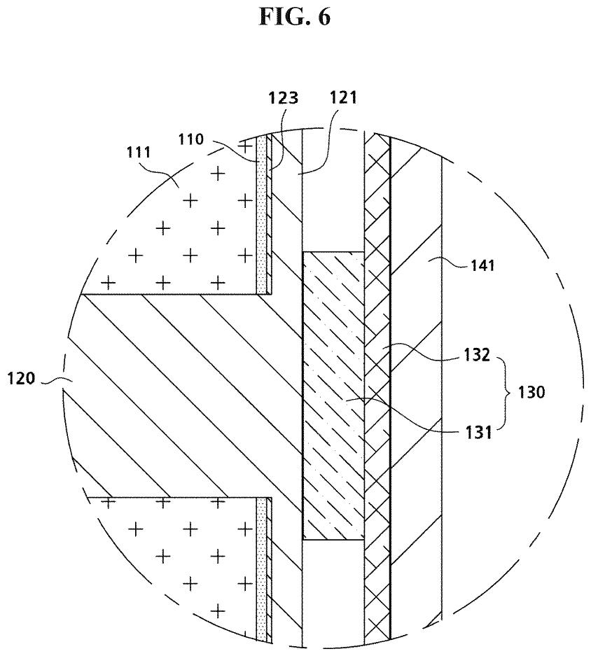

FIG. 1 is a schematic configuration diagram of an air purifying system according to an embodiment of the present disclosure; FIG. 2 is an exploded perspective diagram of an air purifier included in an air purifying system according to an embodiment of the present disclosure; FIG. 3 is a cross-sectional diagram of an air purifier according to an embodiment of the present disclosure; FIG. 4 is an example of a light-transmitting member according to an embodiment of the present disclosure; FIGS. 5 and 6 are enlarged diagrams of the part “A” of FIG. 3 according to an embodiment of the present disclosure.

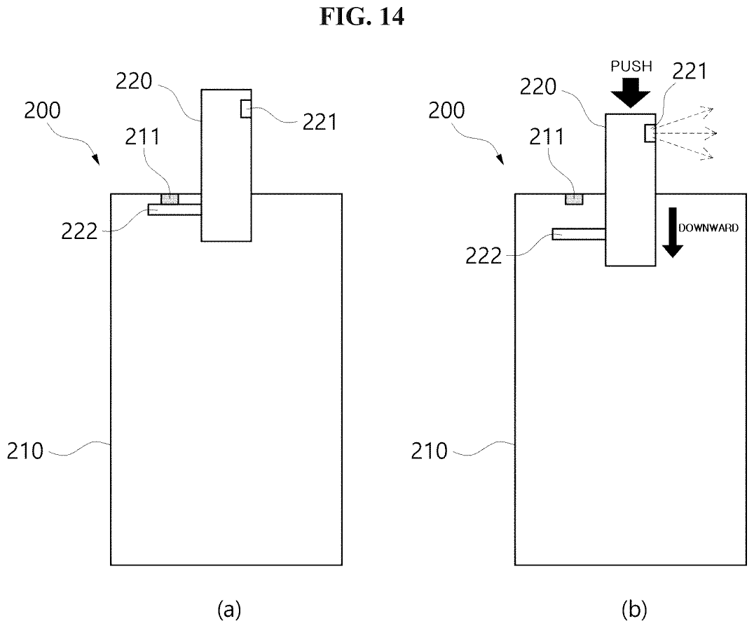

FIG. 14 is an example illustrating the structure of the interior of a sprayer included in an air purifying system of FIG. 1 according to an embodiment of the present disclosure.

Referring to FIGS. 1 to 6 and FIG. 14, an air purifying system 10 according to an embodiment of the present disclosure may broadly comprise an air purifier 100 and a sprayer 200.

The air purifier 100 may comprise a plurality of light-transmitting members 120 that penetrate a moss sheet 110 in the direction of the height of moss 111.

The plurality of light-transmitting members 120 enable sufficient light to be supplied from the top to the lower part of the moss 111.

The plurality of light-transmitting members 120 may form a display to display various information by the on/off operation of each member.

The sprayer 200 may be a device to spray water onto the moss 111 in the air purifier 100.

The sprayer 200 may be configured to store water inside and to spray water through a simple user operation.

The air purifier 100 and the sprayer 200 are described in detail below.

The air purifier 100 may include a moss sheet 110. The moss sheet 110 may be formed of a sheet or a panel on which the moss 111 is planted on its front surface.

The moss sheet 110 may be formed of air-permeable nonwoven fabric or cloth. On the rear surface of the moss sheet 110, a moisture-absorbing material (not shown) may be further disposed to supply moisture to the moss 111.

The moss 111 may be planted on the front surface of the moss sheet 110 such that its roots pass through the moss sheet 110, or may be attached to the surface of the moss sheet 110 using an adhesive.

The air purifier 100 may comprise a plurality of light-transmitting members 120. A light-transmitting member may be formed of a transparent or translucent pipe-shaped structure that is made of a light-transmitting material.

Since each light-transmitting member 120 is formed of a transparent or translucent pipe-shaped structure having a hole inside, light may be irradiated not only forward but also upward, downward, to the left, and to the right while passing through the light-transmitting member 120.

The light-transmitting member 120 may preferably be formed to have a height that reaches the top of the moss 111 planted on the moss sheet 110.

Referring to (a) in FIG. 4, in a conventional moss sheet 401, when light is irradiated from the outside, the photosynthesis occurs only at the top of the moss, whereas, in a moss sheet 402 according to an embodiment of the present disclosure, light is uniformly supplied through the light-transmitting members 120, thereby enhancing the activity of the moss by an average of three times or more.

That is, the moss sheet 401 may be divided into an active region at the top where external light is transmitted and an inactive region at the lower part where external light is not transmitted. On the other hand, the moss sheet 402 does not depend on external light, and thus, the entire area may become an active region.

Although it may differ depending on the density, length, or growth degree, the active region of the moss sheet 402 according to an embodiment of the present disclosure may have, in particular, a region with an activity level three times greater than that of the moss sheet 401, as shown in (a) of FIG. 4.

In addition, referring to (b) of FIG. 4, in the moss sheet 402, light may be uniformly supplied to the entire area of moss in the direction of the height of the moss 111. In (b) of FIG. 4, a case is shown where the light-transmitting member 120, having the above-described pipe-shaped structure, is in the form of lighting pole.

Unlike the moss sheet 401 that requires external light, the moss sheet 402 may be installed in various areas and locations so as to have high interior decorative value, and may be combined with various home appliances.

According to an embodiment, the light-transmitting member 120 may be formed to have a height equal to or greater than the height of the moss 111. In this case, the end of the light-transmitting member 120 may protrude from the moss 111.

According to another embodiment, the light-transmitting member 120 may be formed to have a height less than that of the moss 111. In this case, the end of the light-transmitting member 120 may be covered by the end of the moss 111.

According to the present disclosure, the light-transmitting member 120 may preferably be formed to have a height within a range of −5 to +5 mm from the height of the moss 111.

Either in the case where the light-transmitting member 120 protrudes from the moss 111 or in the case where it is covered by the moss 111, the light-transmitting member 120 may be formed such that sufficient light can be supplied up to its end, so that light may be sufficiently recognized from the outside. This configuration is intended to form a display unit using a plurality of light-transmitting members 120.

The light-transmitting member 120 may be disposed to correspond to the entire area of the moss sheet 110, so that the light-transmitting member 120 may be provided throughout the entire part of the moss 111.

In another embodiment, a plurality of light-transmitting members 120 may be formed to have different heights. For example, some of the light-transmitting members 120 may be formed to have heights equal to or greater than the height of the moss 111, and others may be formed to have heights less than the average height of the moss 111 so that they are covered by the moss 111.

When the light-transmitting members 120 have different heights, various information can be provided using some externally exposed light-transmitting members 120, while preventing the user's discontent with excessive light leakage caused by numerous light-transmitting members 120. For example, some externally exposed light-transmitting members may be configured to form an analog clock to display time, or to form letters or emoticons.

According to an embodiment, the light-transmitting member 120 may be in a circular or polygonal column shape. For example, the light-transmitting member 120 may be in a cylindrical shape.

In addition, although it is not shown, the light-transmitting member 120 may have patterns or unevenness on its outer surface. For example, the light-transmitting member 120 may have multiple scratches on the outer surface so that light may diffuse in various directions. The patterns or unevenness may enable the light-transmitting member 120 to adjust transmittance.

The light-transmitting member 120 may be formed of a material that is resistant to moisture and heat (anti-deformation). For example, the light-transmitting member 120 may be formed of glass or synthetic resin.

The air purifier 100 may comprise a panel unit 121 to integrate a plurality of light-transmitting members 120. Each light-transmitting member 120 actually has a small diameter (for example, about 2-5 mm) and a small height (for example, about 20-30 mm).

When considering this matter, it is difficult to individually install the light-transmitting members on the moss sheet 110, and the installed light-transmitting members may have different heights.

When integrating the light-transmitting members 120 using a single panel unit 121, the light-transmitting members may be installed en bloc on the moss sheet 110.

In particular, since all the light-transmitting members 120 are integrated in a single panel unit 121, their heights may be thus uniform, and the light-transmitting members may be uniformly installed on the moss sheet 110.

Referring to FIG. 6, the light-transmitting members 120 according to an embodiment of the present disclosure may be formed as a single body with the panel unit 121. That is, the panel unit 121 and the light-transmitting members may be injection-molded using a single injection mold, which reduces the manufacturing costs.

Referring to FIG. 5 as another embodiment, the panel unit 121 may have a plurality of holes (or apertures) 122 that correspond one-to-one to a plurality of light-transmitting members 120. The light-transmitting members 120 may be combined with the respective holes 122 to be integrated.

In the case where the panel unit 121 and a plurality of light-transmitting members 120 are formed as a single body, the panel unit 121 may be formed of the same transparent material as that for each light-transmitting member 121. In this case, a non-transparent shielding plate 123 may be further provided between the front surface of the panel unit 121 and the moss sheet 110.

The shielding plate 123 may be formed such that light is not supplied to the part of the panel unit 121 other than a plurality of light-transmitting members 120. That is, further disposing the shielding plate 123 focuses light on the respective light-transmitting members 120. In this case, the shielding plate 123 may be formed as a thin film.

In the case where the panel unit 121 and the light-transmitting members 120 are separately manufactured, and then, integrated with each other, the panel unit 121 may be formed of a non-transparent material.

The air purifier 100 may comprise a light source unit 130. The light source unit 130 may comprise a plurality of light sources. The plurality of light sources may correspond to a plurality of light-transmitting members 120 one-to-one. The light sources may be, for example, LEDs.

The light source unit 130 may be disposed at the rear surface of the moss sheet 110 and configured to supply light toward a plurality of light-transmitting members that penetrate the moss sheet 110.

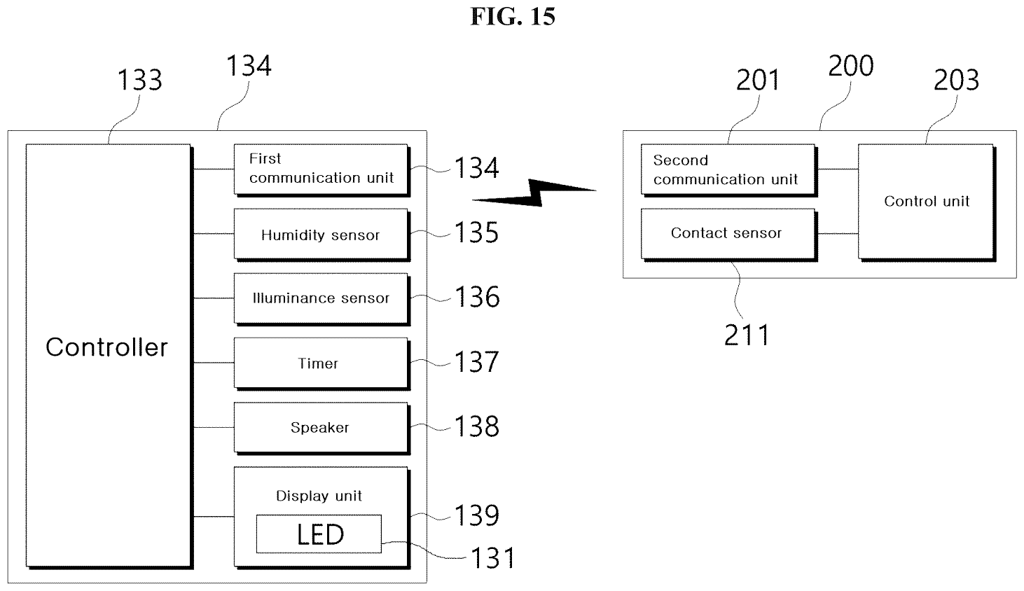

The light source unit 130 may comprise, as shown in FIG. 5, a plurality of LEDs 131, a board (PCB) 132 on which the LEDs 131 are mounted, and a controller (133 in FIG. 15) that turns on or off the LEDs 131.

The board 132 may be located on the rear side of the moss sheet 110 and the LEDs 131 may be mounted on the front surface of the board 132.

Each LED 131 may be provided to each light-transmitting member 120 in a one-to-one manner, or one LED 131 may be provided for a certain number of light-transmitting members 120.

An LED 131 may be disposed at a location closest to the lower part of a light-transmitting member 120. Disposing the LED 131 closest to the light-transmitting member 120 may prevent the dispersion of light, supplied when the LED 131 emits light, to parts other than the light-transmitting member 120.

In addition, when the LED 131 is closer to the light-transmitting member 120, heat generated by the LED 131 while emitting light is smoothly transferred to the light-transmitting member 120, and the heat conducted along the light-transmitting member 120 may serve to prevent the moss 111 around the member from going moldy.

A plurality of LEDs 131, a plurality of light-transmitting members 120, and the board 132 may form a display unit (139 in FIG. 15). The display unit 139 may display various information by selectively turning on or off the plurality of LEDs 131.

The display unit 139 may operate by control of the controller 133.

The controller 133 may selectively and individually turn on or off the LEDs 131 to correspond to information to be displayed.

It is preferred that the number of LEDs 131 forming the display unit 139 be greater. The reason is that the greater the number of LEDs 131 is, the information may be displayed at the higher resolution. However, the number of LEDs 131 may be determined with comprehensive consideration of the size of the air purifier 100 and manufacturing costs.

Each LED 131 may either emit light of a single color or simultaneously or selectively emit multiple colors. In the case of a single color, it may be, for example, white. In the case of multiple colors, for example, a single LED 131 may be formed by combining R, G, and B LED cells so that colored light from the combination of R, G, and B lights may be emitted.

When the LED 131 emits light, the light emitted from the LED 131 is transferred to the relevant light-transmitting member 120 and passes through the light-transmitting member 120. Since the shielding plate 123 is provided between the panel unit 121, on which the light-transmitting member 120 is mounted, and the board 132 of the light source unit 130, the light from the LED 131 is transferred only to the light-transmitting member 120 because of the shielding plate 123 and passes through the light-transmitting member 120.

In this way, the moss 111 on the moss sheet 110 through which the light-transmitting members 120 pass may be supplied with light that passes through the light-transmitting members 120.

The moss 111 may receive light uniformly from the top through the middle to the lower part (the root part) and perform photosynthesis. That is, the total frontal elevation area of the moss 111 can be used for photosynthesis, which enhances the air purifying performance.

It is also possible that only some of a plurality of LEDs 131 are controlled by the controller 133 to emit light so that only some light can pass through the relevant light-transmitting members 120.

In this way, only some of a plurality of LEDs 131 are selectively turned on to emit light, which enables various information to be displayed.

According to an embodiment of the present disclosure, the air purifier 100 may comprise a case 140.

The case 140 may form the exterior of the air purifier 100 that surrounds the border and the rear surface of the moss sheet 111.

The case 140 may be formed in the form of a small frame type having a rectangular frame with a rear wall 141, which enables the air purifier to serve as an interior accessory that can be hung on an interior wall or placed on a desk.

The LEDs 131 of the light source unit 130 may be provided between the rear surface of the moss sheet 110 inside the case 140 and the rear wall 141 of the case 140. The controller 133 may be provided inside the edge of the case 140, which forms a rectangular frame.

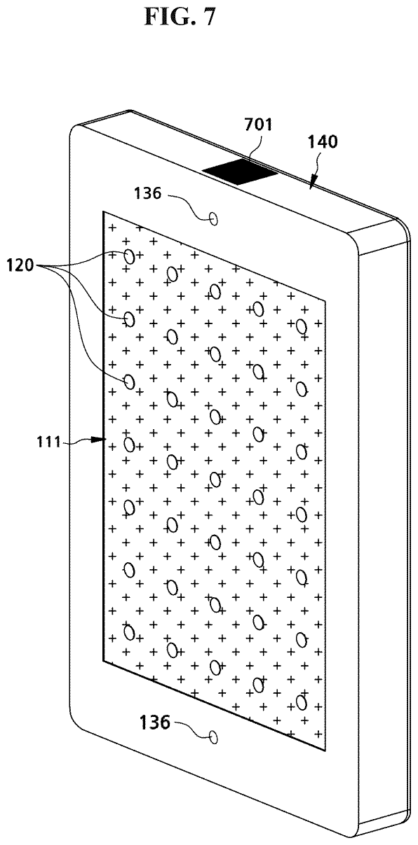

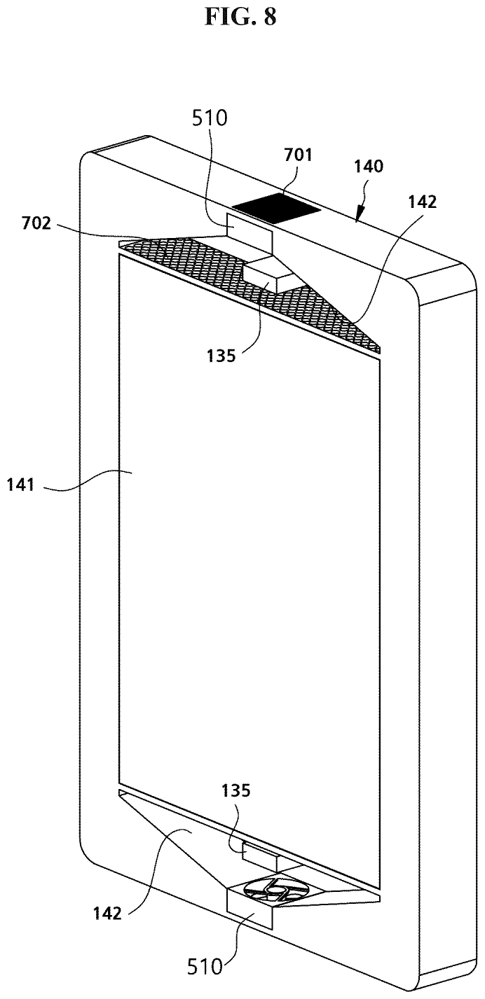

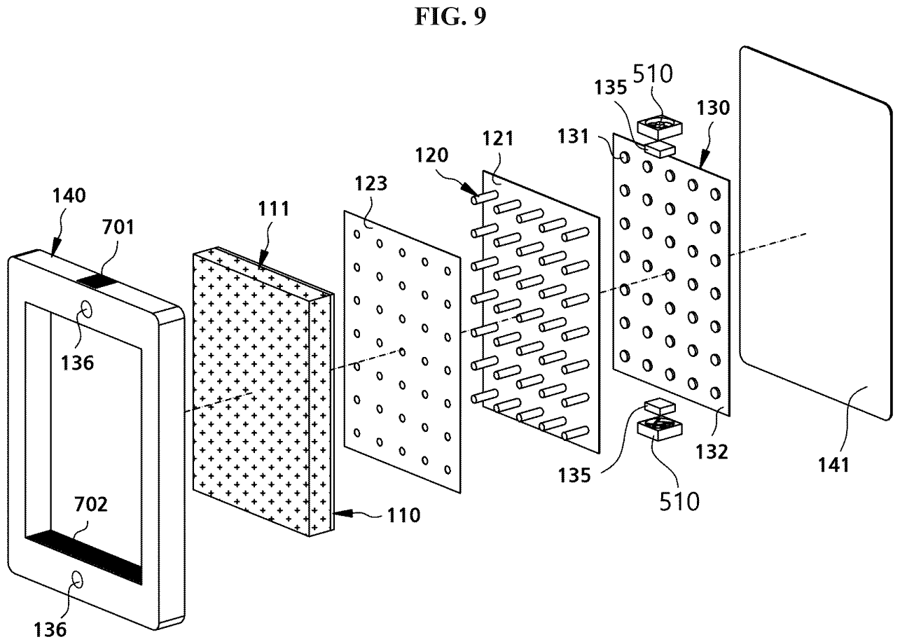

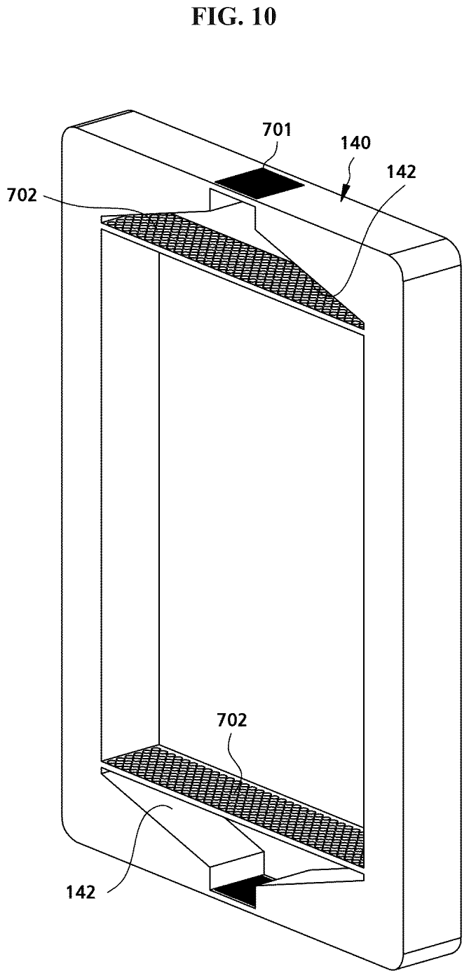

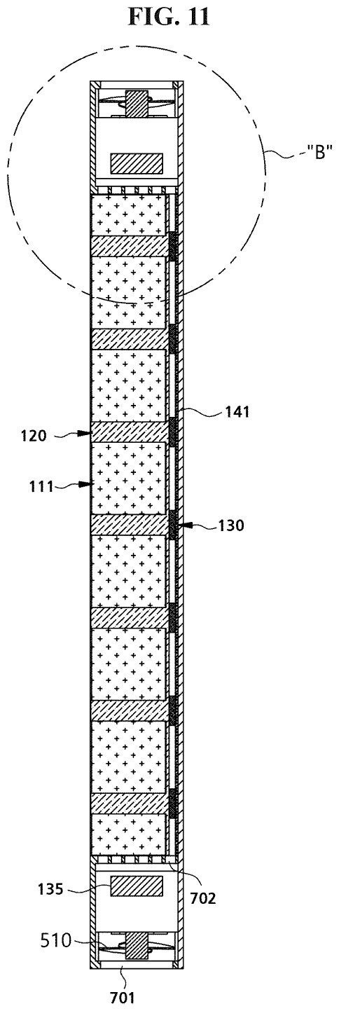

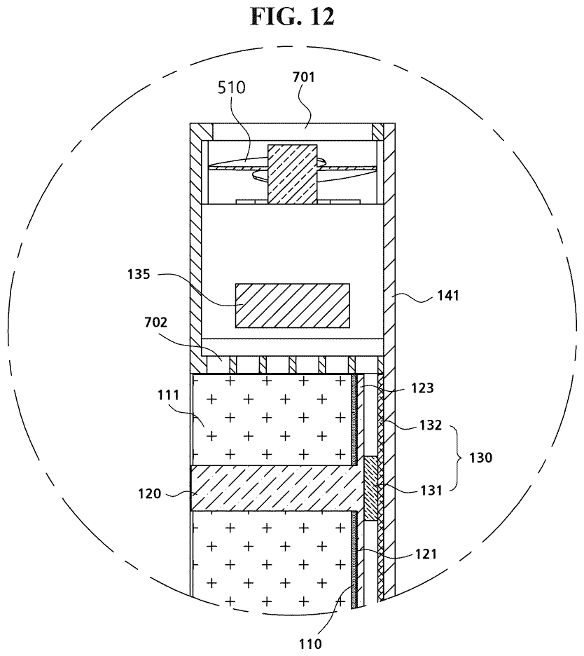

As another example, the air purifier according to the present disclosure may further comprise a blower fan 510 that blows air to the moss depending on the moisture supply or the light emission of the LEDs 131, as shown in FIGS. 7 to 12.

The blower fan 510 may selectively operate by the control of the controller 133, and the case 140 that forms the air purifier may include an inlet 701, through which external air may be sucked in through the operation of the blower fan 510, and an outlet 702.

The inlet 701 may be formed in at least one of outer peripheral surfaces of the case 140. For example, the case 140 may include inlets 701 respectively formed in an outer upper surface and an outer lower surface. Although it is not shown, the inlet 701 may be formed any one of the rear or front surface of the case 140.

The case 140 may include outlets 702 respectively formed in an inner upper surface and an inner lower surface. In particular, the outlet 702 may be in the form of a plurality of holes formed in the inner upper surface and the inner lower surface of the case 140.

The case 140 may further comprise a guide 142 that enables air sucked in through the inlet 701 to disperse in the width direction of the moss sheet 110. The guide 142 may be formed in the form of a slope so that the air sucked through the inlet 701 can disperse in the entire inner upper surface and inner lower surface of the case 140.

As still another example, the air purifier according to the present disclosure may further comprise a humidity sensor 135 (see FIG. 15) to confirm the moisture supply, as shown in FIGS. 7 to 12. That is, the prevention of overwatering or overdrying of the moss 111 may be achieved by further providing the humidity sensor 135.

The controller 133 may confirm whether water is supplied to the moss 111 using humidity information detected by the humidity sensor 135 and, when it is determined that water has been supplied to the moss 111, control the LEDs 131 to emit light. In this way, the photosynthetic effect may be further enhanced to maximize the natural purification capability.

The controller 133 may also control the blower fan 510 to operate when the LEDs 131 emit light.

When the humidity confirmed by the humidity sensor 135 is in the range of overwatering, the controller 133 controls the operations of the LEDs 131 and the blower fan 510 to reduce the humidity. In this way, damages to the moss 111 due to the overwatering or overdrying may be prevented.

When the moss 111 is supplied with light having a lower illuminance than a predetermined illuminance, the controller 113 may control the LEDs 131 to emit light. This is intended to reduce electric power consumption that may be caused by the light emission of the LEDs 131 even though the surroundings are bright.

For this purpose, the case 140 may further comprise an illuminance sensor 136 (see FIGS. 7, 9, and 15) to confirm the illuminance of the moss 111. Here, the illuminance sensor 136 may be provided on the front surface of the case 140. That is, the optimum photosynthesis of the moss 111 may be achieve by further providing the illuminance sensor 136.

The controller 330 may also perform control simultaneously using the humidity sensor 135 and the illuminance sensor 136.

That is, the controller may control the light emission of the LEDs 131 and the operations of the blower fan 510 based on the humidity and illuminance obtained by the humidity sensor 135 and the illuminance sensor 136, thereby obtaining the enhanced photosynthetic effect.

In the case where it is identified, for example, that the humidity increases in an instant when the illuminance is low, the controller 133 may control the LEDs 131 to emit light and the blower fan 510 to operate so that the moss 111 can perform photosynthesis. This may maximize the photosynthetic effect.

In particular, the controller 133 may display a drying state (overdrying state, appropriate state, overwatering state, etc.) using the LEDs 131 and the light-transmitting members 120 to induce a user's water supply to the moss 111 at an exact timing.

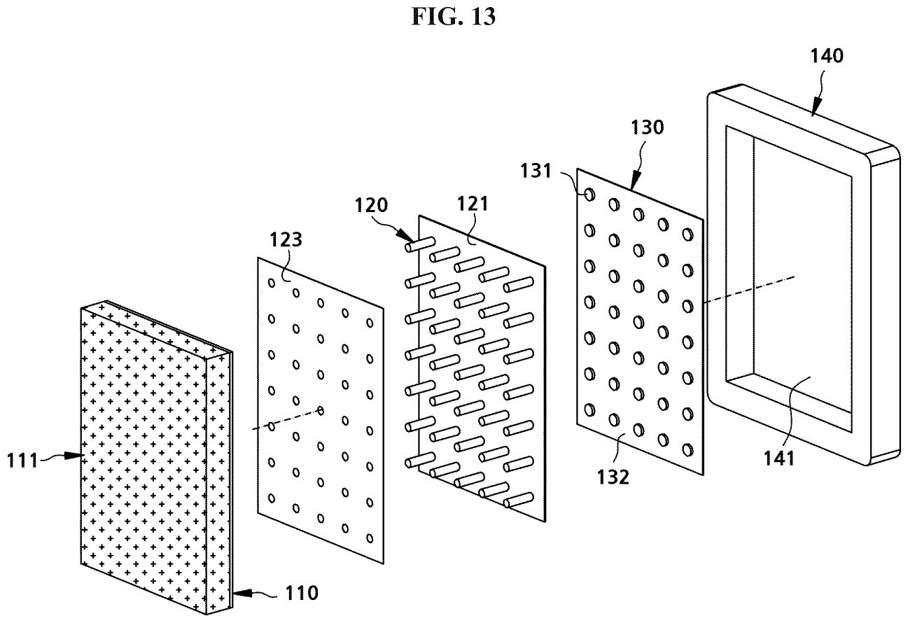

FIG. 13 is an exploded perspective diagram of an air purifier according to another embodiment of the present disclosure. FIG. 13 illustrates, as an example, a case in which the panel unit 121 and a plurality of light-transmitting members 120 are formed as a single body. The light-transmitting members 120 of the single body formed by the light-transmitting members 120 and the panel unit 121 pass through the shielding plate 123 and the moss sheet 110 to be located among the moss 111.

Hereinafter, the sprayer 200 involved in certain embodiments is described with reference to FIG. 14.

The sprayer 200 may spray water to the moss 111 of the air purifier 100.

The sprayer 200 may communicate with the air purifier 100 in a wireless manner.

When referring to an example of FIG. 14, the sprayer 200 may comprise a pushing member 220 at an upper end of a body 210. When a user pushes the pushing member 220, water may be sprayed (or injected) through a spraying aperture 221.

On one side of the body 210, a contact sensor 211 may be provided, and on one side of the pushing member 220, a contact member 222 may be disposed.

The contact member 222 may be configured to be in contact with the contact sensor 211 under normal conditions, and to be released from contact with the contact sensor 211 when the pushing member 220 is pushed.

The contact sensor 211 may be configured to detect contact or release of contact (separation) of the contact member 222.

When the pushing member 220 is pushed, water is sprayed through the spraying aperture 221 and the contact sensor 211 detects separation of the contact member 222.

As such, the contact sensor 211 detects the contact or separation of the contact member 222. Since the separation of the contact member 222 occurs together with water spraying, the detection of the separation of the contact member 222 by the contact sensor 211 may correspond to the detection of water spraying. Therefore, in this embodiment, the contact sensor 211 may be referred to as a water spraying detection sensor that detects water spraying.

FIG. 14 illustrates an example of the sprayer 200, and the present disclosure is not limited to this example. In particular, in the case of the sprayer 200, any device or component that can spray water and detect water spraying may serve as a sprayer according to the present disclosure.

For example, although it is not shown in the figures, a typical sprayer that sprays water by pulling a handle (lever) may be used. This sprayer also may comprise a contact sensor and a contact member that may come in contact with or separate from each other.

In this case, the handle (lever) or a member connected to the handle is configured to be in contact with the contact sensor under normal conditions and to be separated from the contact sensor simultaneously with water spraying when the handle is pulled for water spraying.

As such, a sprayer having any device or component that can detect water spraying may be adopted as the sprayer 200 according to the present disclosure.

FIG. 15 is a configuration block diagram illustrating the operation of an air purifying system according to an embodiment of the present disclosure.

Referring to FIG. 15, the air purifier 100 may comprise at least one of a controller 133, a first communication unit 134, a humidity sensor 135, an illuminance sensor 136, a timer 137, a speaker 138, and a display unit 139, and the sprayer 200 may comprise a second communication unit 201, a contact sensor 202, and a control unit 203.

The first communication unit 134 performs wireless communication with the second communication unit 201. The wireless communication may be RF communication, Bluetooth communication, NFC communication, Zigbee communication, Wi-Fi communication, etc.

The humidity sensor 135 may measure humidity of the moss 111. The controller 133 may determine the necessity of water spraying based on humidity measured by the humidity sensor 135.

The humidity sensor 135 enables the prevention of overwatering or overdrying of the moss 111.

The controller 133 may identify water supply to the moss using humidity information obtained by the humidity sensor 135 and, when it is identified that water has been supplied to the moss 111, may control the LEDs 131 to emit light. In this way, the photosynthetic effect may be further enhanced to maximize the natural purification capability.

According to an embodiment, the illuminance sensor 136 may measure the illuminance of light irradiated through the light-transmitting members 120. In this case, the controller 133 may adjust the brightness of light based on the illuminance measured by the illuminance sensor 136.

According to another embodiment, the controller 133 may also calculate the illuminance of light irradiated to the moss 111 in a predetermined area of the moss sheet 110 through the light-transmitting members 120 based on arrangement information of a plurality of LEDs 131 in the light source unit 130 and/or type information of the LEDs 131, which are antecedently registered. In this case, the controller 133 may adjust the brightness of light in each predetermined area of the moss sheet 110 based on the calculated illuminance. For this purpose, the controller 133 may antecedently store an algorithm for calculating the path and/or intensity of light formed depending on the type and arrangement of LEDs.

For example, the illuminance sensor 136 may be provided on the front surface of the case 140. Using illuminance information measured by the illuminance sensor 136, the optimum photosynthesis of the moss 111 may be achieved.

The controller 133 may perform control simultaneously using the humidity sensor 135 and the illuminance sensor 136. The control of light emission of the LEDs 131 may be performed based on the humidity and illuminance obtained by the humidity sensor 135 and the illuminance sensor 136, and thus, a more enhanced photosynthetic effect may be obtained.

The controller 133 may also maximize the photosynthetic effect by calculating the path and/or intensity of light applied to a predetermined area based on the arrangement information or type information of the LEDs 131 and adjusting the illuminance of light in each area, as in the above-described embodiment, in addition to using the humidity sensor 135 and the illuminance sensor 136.

The timer 137 may count the time elapsed from a predetermined time point.

The timer 137 may transmit the counted time to the controller 130.

The speaker 138 may output predetermined sounds. The speaker 138 may output predetermined sounds according to the control of the controller 130. For example, the speaker 138 may output pre-recorded sounds, music, or melodies.

The display unit 139 may include a plurality of light-transmitting members 120 and LEDs 131. The plurality of LEDs 131 may be mounted on the board 132 and their on/off states may be individually controlled by the controller 133. When an LED 131 is turned on, light may be emitted and irradiated in the forward, upward, downward, to the left, and to the right directions through the light-transmitting members 120.

The air purifier 100 may display various information on the display unit 139 using light emitted forward when viewed from the front.

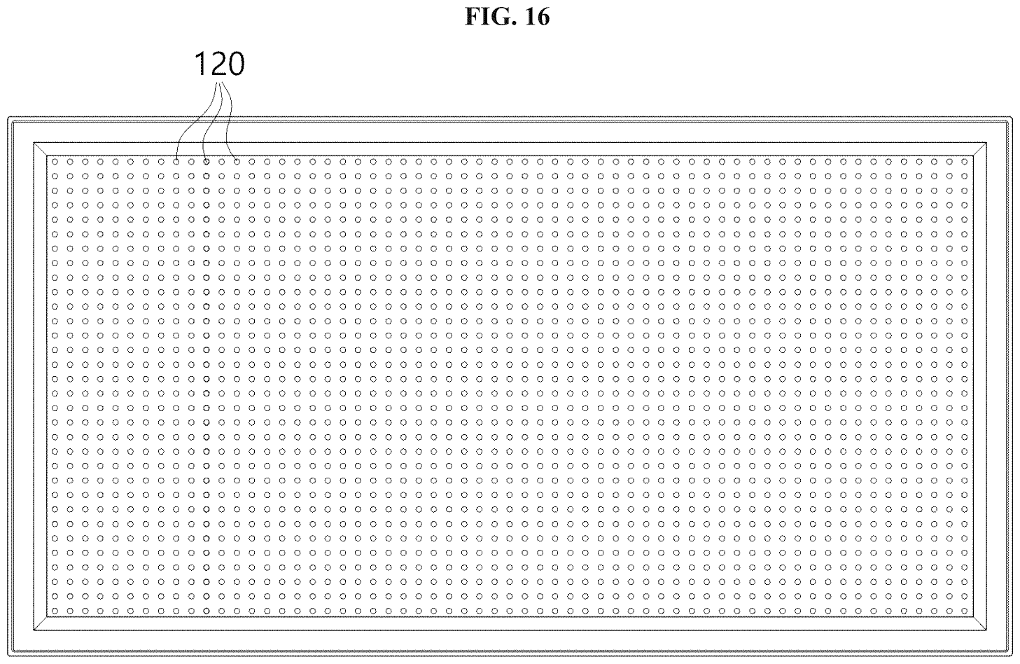

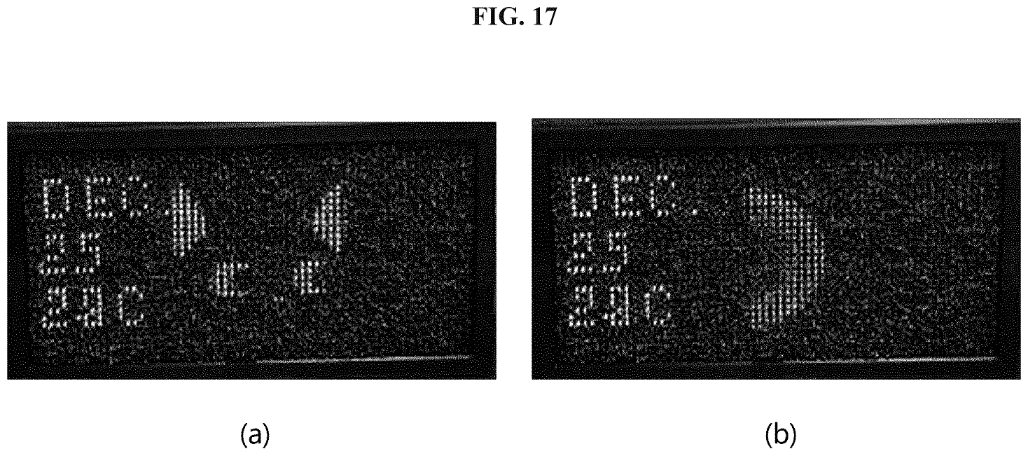

FIG. 16 illustrates, as an example, a plurality of light-transmitting members 120 that form the display unit 139 in the state in which the moss 111 is excluded. FIG. 17 illustrates examples in which information is displayed by turning on some of LEDs 131 to emit light in the state in which the moss 111 is combined.

The display unit 139 may display various sentences, pictures, characters, etc.

The display unit 139 may display various information related to water spraying, such as a request for water spraying or a stop of water spraying, and life information, such as weather, time, day of week, news, etc.

The second communication unit 201 may perform wireless communication with the first communication unit 134.

When water spraying is detected by the contact sensor 211, the sprayer 200 may notify the start of water spraying through the second communication unit 201 to the first communication unit 134.

The contact sensor 211 may sense that the pushing member 220 is pushed and may sense water spraying, as described above.

According to an embodiment, the controller 133 may control the first information displayed on the display unit 139 to be changed to the second information based on the reception of the notification of the detection of water spraying by the contact sensor 211 and/or on the measurement of humidity by the humidity sensor 135. In this way, a user may verify that an appropriate amount of water has been supplied to the moss 111.

The controller 133 may extract information about LEDs used for displaying information on the display unit 139 among all the LEDs 131, and identify information about the light emission time of the LEDs, for which the information has been extracted, that is continued for supplying information.

In this way, the controller 133 may determine that light has been continuously applied to the moss 111 in a predetermined area of the moss sheet 110 and control the LED in other areas, for which information has not been extracted, to emit light so that light may also be supplied to the moss in the other areas for a predetermined time to improve the photosynthetic efficiency. Accordingly, the moss 111 in the whole area of the moss sheet 110 may perform photosynthesis at high efficiency.

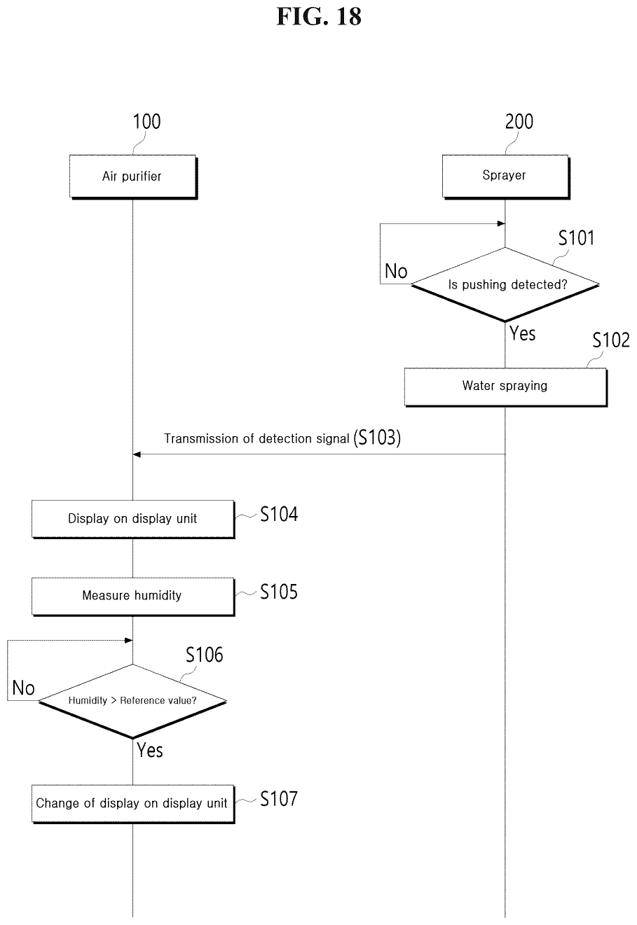

FIG. 18 is a flow diagram illustrating the operation of an air purifying system according to an embodiment of the present disclosure.

Referring to FIG. 18, in the air purifying system 10 according to an embodiment of the present disclosure, when the pushing member 220 is detected to be pushed (S101), the sprayer 200 sprays water (S102).

Simultaneously or sequentially, the sprayer 200 transmits a pushing detection signal to the air purifier 100 (S103). The transmission of the signal may be performed through wireless communication between the first and second communication units 134, 201.

As described above, the detection that the pushing member 220 has been pushed may indicate the detection of water spraying. Therefore, the pushing detection signal may serve as a water spraying start signal.

When receiving the pushing detection signal or the water spraying start signal from the sprayer 200, the air purifier 100 displays predetermined information on the display unit 130 (S104).

The information displayed in S104 may be information related to water spraying, to which a user can refer when spraying water.

For example, the information may indicate where water should be sprayed (the position to be sprayed with water), how much water should be sprayed (the amount of water to be sprayed), or for how many seconds or minutes water should be sprayed (the water spraying time).

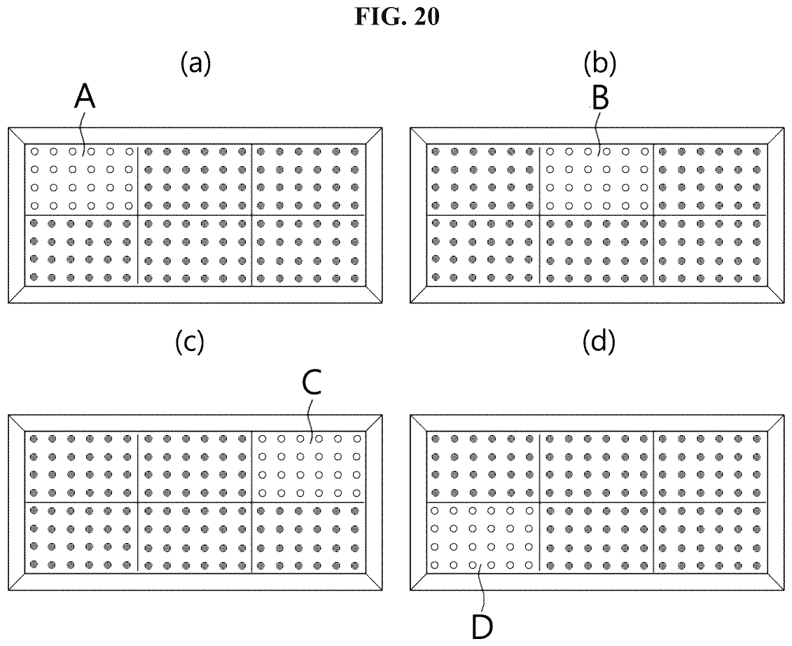

As another example, the entire area of the front surface of the display unit 139 may be divided into a plurality of regions, and light may be emitted sequentially in these regions for a predetermined time, as shown in FIG. 20. In this way, a user may be induced to spray water sequentially along these regions. In this case, a sentence stating that “Please spray water along the illuminated regions” may be antecedently displayed.

FIG. 20 shows an example in which the entire area of the display unit 139 is divided into six regions. Among the six regions, only region A emits light for a predetermined time, and then, only region B, only region C, only region D, etc. may sequentially emit light. In this way, a user may be induced to spray water only to the illuminated region, which allows a user to more uniformly spray water by referring to the information displayed on the display unit 139 than in the case where water is sprayed to the entire area. Such a region division may be applied to an air purifier having a big size.

When water spraying is started, the humidity sensor 135 may measure the humidity (S105).

When the humidity is equal to or higher than a reference value (S106), the controller 133 may change information to be displayed on the display unit 139 (S107).

The information changed in S107 may be information that requests the stop of water spraying.

For example, when the humidity is equal to or higher than the reference value, it is determined that an appropriate amount of water has been supplied, and a sentence requesting the stop of water spraying may be displayed.

In another embodiment, the steps S105 and S106 may proceed differently. For example, instead of measuring humidity, the timer 137 may count the time elapsed after water spraying and, when the elapsed time reaches a reference time, the controller 133 may change information to be displayed on the display unit 139 (S107).

The changed information may be information that requests the stop of water spraying based on the determination that water has been sufficiently supplied within the elapsed time.

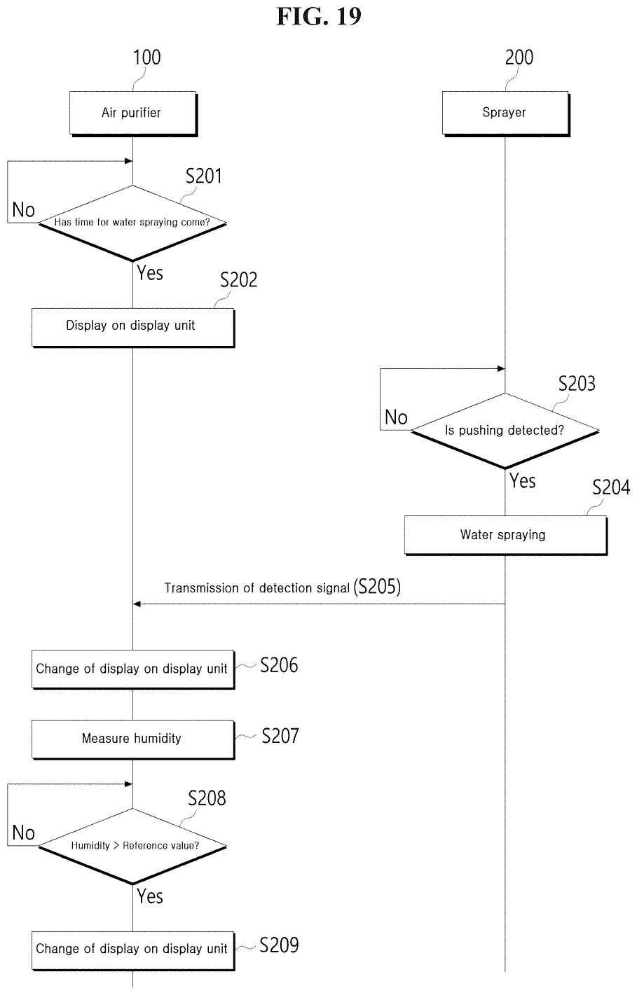

FIG. 19 is a flow diagram illustrating the operation of an air purifying system according to another embodiment of the present disclosure.

Referring to FIG. 19, in the air purifying system 10 according to another embodiment of the present disclosure, the air purifier 100 in a standby state determines whether a time for water spraying has come (S201).

Whether a time for water spraying has come may be determined using the time elapsed after previous water spraying or information on humidity measured by the humidity sensor 136.

When it is determined that a time for water spraying has come, predetermined information may be displayed on the display unit 139 (S202). For example, a sentence requesting water spraying, such as ‘Please spray water’, ‘Moss is dry’, or ‘Please supply water sufficiently’, may be displayed.

A user, who watches the sentence displayed on the display unit 139, can spray water using the sprayer 200.

When the sprayer 200 detects that the pushing member 220 has been pushed (S203), the sprayer 200 sprays water (S204). Simultaneously or sequentially, the sprayer 200 transmits a pushing detection signal to the air purifier 100 (S205). The pushing detection signal may serve as a water spraying start signal.

When the pushing detection signal or water spraying start signal is received from the sprayer 200, the air purifier 100 may change predetermined information to be displayed on the display unit 139 (S206).

The information displayed in S206 may be information related to water spraying, to which a user can refer when spraying water. For example, the information may indicate the position to be sprayed with water, or how much water should be sprayed. The user may spray water by referring to the information displayed on the display unit 139.

When water spraying starts, the humidity sensor 135 may measure humidity (S207).

When the humidity is equal to or higher than a reference value (S208), the controller 133 may change information to be displayed on the display unit 139 (S209).

The information changed in S209 may be information that requests the stop of water spraying.

For example, when the humidity is equal to or higher than the reference value, it is determined that an appropriate amount of water has been supplied, and a sentence requesting the stop of water spraying may be displayed.

In another embodiment, the steps S207 and S208 may proceed differently. For example, instead of measuring humidity, the timer 137 may count the time elapsed after water spraying and, when the elapsed time reaches a reference time, the controller 133 may change information to be displayed on the display unit 139 (S209).

The changed information may be information that requests the stop of water spraying based on the determination that water has been sufficiently supplied within the elapsed time.

Under normal conditions, the display unit 139 may display information that a user wants or information predetermined by the air purifier 100. For example, life information such as weather, time, day of week, news, etc. may be displayed.

Then, when water spraying by the sprayer 200 is detected or when water spraying is requested by the air purifier 100, information may be changed depending on conditions.

The air purifier 100 may also output music through the speaker 138.

The air purifier according to the present disclosure and the air purifying system comprising the air purifier are not limited to the configurations described in the above-described embodiments.

For example, although it is not shown, the air purifier may not comprise the shielding plate 123 even though the light concentration decreases. As such, the air purifier according to the present disclosure may be implemented and modified in various forms.

In the foregoing description, all the components constituting the embodiments according to the present disclosure have been described as being combined into one or operating in combination; however, the present disclosure is not necessarily limited to such embodiments. That is, within the scope and spirit of the present disclosure, all the components may be selectively combined into one or more and may operate accordingly. In addition, the terms “comprise,” “comprising,” “have,” or “having,” as used herein, unless specifically stated otherwise, are intended to indicate the possibility of inclusion of the corresponding components, and thus should be interpreted to allow inclusion of additional components rather than exclusion of other components. All terms, including technical or scientific terms, unless otherwise defined, have the same meaning as commonly understood by those skilled in the art to which the present disclosure pertains. Terms generally used, such as those defined in dictionaries, should be interpreted as being consistent with the contextual meaning in the relevant technology and, unless explicitly defined in the present disclosure, should not be interpreted in an idealized or overly formal sense.

The above description is merely illustrative of the technical spirit of the present disclosure, and various modifications and variations can be made by those skilled in the art to which the present disclosure pertains without departing from the essential characteristics of the present disclosure. Therefore, the embodiments disclosed herein are not intended to limit the technical spirit of the present disclosure but to describe it, and the scope of the technical spirit of the present disclosure is not limited by such embodiments. The scope of protection of the present disclosure should be interpreted according to the following claims, and all technical ideas within the equivalent scope thereof should be interpreted as being included within the scope of rights of the present disclosure.

What is claimed is:

1. An air purifier using moss comprising:
a moss sheet on which moss is planted on a front surface;
a plurality of light-transmitting members installed to penetrate the moss sheet and the moss and formed of a transparent material so that light may pass through; and
a light source unit disposed on a rear surface of the moss sheet to supply light to the respective light-transmitting members.

2. The air purifier of claim 1, wherein each light-transmitting member is formed in a rod or pipe shape having a height reaching the top of moss planted on the moss sheet.

3. The air purifier of claim 1, further comprising a panel unit, in which the light-transmitting members are integrated.

4. The air purifier of claim 3, wherein the panel unit is formed of a non-transparent material.

5. The air purifier of claim 3, further comprising a non-transparent shielding plate between the front surface of the panel unit and the moss sheet.

6. The air purifier of claim 1, further comprising a case that surrounds the border and the rear surface of the moss sheet, wherein the light source unit is provided between the rear surface of the moss sheet and the case.

7. The air purifier of claim 6, wherein the case comprises an air inlet, through which air is sucked in, and a blower fan that blows the air sucked in through the air inlet.

8. The air purifier of claim 7, wherein the case further comprises a humidity sensor that senses humidity and a controller that controls the humidity by operating the blower fan using humidity information sensed by the humidity sensor.

9. The air purifier of claim 6, wherein the case further comprises an illuminance sensor that senses illuminance and a controller that controls the light source unit using illuminance information sensed by the illuminance sensor.

10. The air purifier of claim 1, wherein the light source unit comprises a board having multiple light-emitting devices (LEDs) and a controller that controls the light emission of each LED.

11. An air purifying system using moss including:
an air purifier comprising moss and a display unit; and
a sprayer that sprays water onto the moss in communication with the air purifier,
wherein the air purifier detects water spraying by the sprayer and changes information displayed on the display unit.

12. The air purifying system of claim 11, wherein the display unit comprises a plurality of light-transmitting members formed of a transparent material to allow light to pass through and a light source unit that supplies light to the respective light-transmitting members.

13. The air purifying system of claim 12, wherein the air purifier comprises a moss sheet on which moss is planted on a front surface, and the plurality of light-transmitting members are installed to penetrate the moss sheet such that the light supplied by the plurality of light-transmitting members is emitted by passing through the moss when viewed from the front.

14. The air purifying system of claim 11, wherein the sprayer includes a water spraying detection sensor that detects whether water is sprayed; and a communication unit that transmits a sensing signal to the air purifier when the water spraying detection sensor detects water spraying.

15. The air purifying system of claim 14, wherein the air purifier changes the information displayed on the display unit when the sensing signal is received from the sprayer.

16. The air purifying system of claim 11, wherein the air purifier further comprises a panel unit, in which the light-transmitting members are integrated, wherein the panel unit may be formed of a non-transparent material.

17. A method of operating an air purifying system, which comprises an air purifier including moss and a display unit, and a sprayer, including the steps of:
transmitting a sensing signal to the air purifier through wireless communication when water spraying by the sprayer is detected; and
displaying, by the air purifier, information on the display unit based on the sensing signal.

18. The method of claim 17, wherein the display unit divides the entire front area into multiple regions such that each region sequentially emits light exclusively for a predetermined time.

19. The method of claim 17, after the step of displaying information on the display unit, further comprising the steps of: in the air purifier, measuring the humidity of the moss; and changing the information displayed on the display unit when the measured humidity is equal to or greater than a predetermined reference value.

20. A method of operating an air purifying system, which includes an air purifier, comprising moss and a display unit, and a sprayer, comprising the steps of:
determining, by the air purifier, whether the time for spraying water has come;
displaying information requesting water spraying on the display unit when the time for spraying water has come;
transmitting a sensing signal to the air purifier through wireless communication when water spraying by the sprayer is detected; and
changing, by the air purifier, the information displayed on the display unit based on the received sensing signal.

21. The method of claim 20, wherein the display unit divides the entire front area into multiple regions such that each region sequentially emits light exclusively for a predetermined time.

22. The method of claim 20, after the step of displaying information on the display unit, further comprising the steps of: in the air purifier, measuring humidity of the moss; and displaying information requesting a stop of water spraying on the display unit when the measured humidity is equal to or greater than a predetermined reference value.
